(19) United States
(12) Patent Application Publication
(10) Pub. No.: US 2006/0064387 A1
(43) Pub. Date: Mar. 23, 2006

(54) Systems and methods for software licensing

(75) Inventors: Sajeeve Jose, Greenacres, FL (US); Joseph LoBuono, Delray Beach, FL (US); Melvyn Standen, Boca Raton, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Information and Communication Networks, Inc.

(21) Appl. No.: 10/947,004

(22) Filed: Sep. 22, 2004

(51) Int. Cl. G06F 17/60

(52) U.S. Cl. 705/59

(57) ABSTRACT

Systems and methods for managing license privileges associated with software offered for an evaluation period are provided. Methods according to the present invention may include installing an application program on a user terminal; transmitting license information necessary to operate the application program from the user terminal to a license management server; storing the license information in a database; monitoring the license information; and disabling the application program when the license information is not current or has expired. Systems according to the present invention may include a user terminal on which an application program is installed; a license management server coupled to the user terminal through a network; and a license monitor that monitors the application program and the license database. The license management server may include a database of license policies for authorizing the use of at least one application program.

### BACKGROUND OF THE INVENTION

The present invention relates generally to software licensing and, more particularly, to systems and methods for implementing and managing temporary software licenses provided to potential customers during a product evaluation period.

Software licenses are often used to deter unauthorized copying or misuse of a given software package. Installing a licensed software application typically requires acceptance of certain provisions by an end user in a software licensing agreement. For example, during an installation process of a software application, the end user is usually required to accept the terms of the license by giving a positive verification response. Accepting the contractual agreement verifies the end user agrees to be bound by the terms and conditions of the software license. This typically includes provisions prohibiting copying and use beyond the intended purposes set forth by the developer or merchant in the license agreement.

For example, during the software installation process, the end user may be presented with a visual prompt and required to check a box labeled “Accept,” using an input means of the standard computer system, such as a mouse or keyboard. Failure to provide a satisfactory verification response halts the software installation process.

Licensed software may include other measures to deter unauthorized copying or use, such as requiring the end user to enter a registration key to complete the software installation process. Another technique used to protect licensed software includes the use of license files and license keys, which may employ cryptographic techniques and unique host identifications to tie the operation of licensed software to a particular computer or computer network. License keys are sometimes used with runtime verification mechanisms that are part of software license management systems. Such software license management systems are desirable for certain types of computing environments such as distributed networks where the possibility of unlicensed or unauthorized use may be great.

These and similar measures, however, may be inappropriate or undesirable for certain other types of software, such as demonstration or trial period software, which are provided to end users for evaluation purposes. Generally speaking, these types of software are intended to be distributed as widely as possible to gain exposure to a large audience of potential buyers. Although widespread distribution of such software is desirable, concerns about unauthorized use during or after the end of the trial period still play a role in providing evaluation copies of software.

For example, evaluation copies may be provided that have a restricted functionality compared to fully licensed versions and may last for a predefined period of time. Because such evaluation software is frequently provided in a network environment, network administrators are often faced with the difficult task of providing multiple software applications to different users each of which may have different licensing requirements (fully licensed, limited functionality, trial period, etc.) and different access privileges.

Accordingly, what is needed is a license management system that can effectively handle the administration of license privileges associated with software provided for an evaluation period.

In view of the foregoing, it would therefore be desirable to provide systems and methods that effectively handle the administration of license privileges associated with software provided for an evaluation period.

### SUMMARY OF THE INVENTION

It is therefore an object of the present invention to provide systems and methods that effectively handle the administration of license privileges associated with software provided for an evaluation period.

These and other objects of the invention are provided in accordance with the principles of the present invention by providing systems and methods for managing license privileges associated with software provided for an evaluation period. Methods according to preferred embodiments of the present invention may include the steps of installing an application program on a user terminal; transmitting license information necessary to operate the application program from the user terminal to a license management server; storing the license information in a database; monitoring the license information; and disabling the application program when the license information is not current or has expired.

Systems according to preferred embodiments of the present invention may include a user terminal on which an application program is installed; a license management server coupled to the user terminal through a network; and a license monitor that monitors the application program and the license database. The license management server may include a database of license policies for authorizing the use of at least one application program.

### BRIEF DESCRIPTION OF THE DRAWINGS

The above and other objects and advantages of the present invention will be apparent upon consideration of the following detailed description, taken in conjunction with the accompanying drawings in which:

FIG. 1 shows a generalized block diagram of a system constructed in accordance with the principles of preferred embodiments of the present invention for the administration of license privileges associated with software provided for an evaluation period.

FIG. 2 is a flow chart illustrating some of the steps involved in providing the administration of license privileges associated with software provided for an evaluation period.

### DETAILED DESCRIPTION OF THE INVENTION

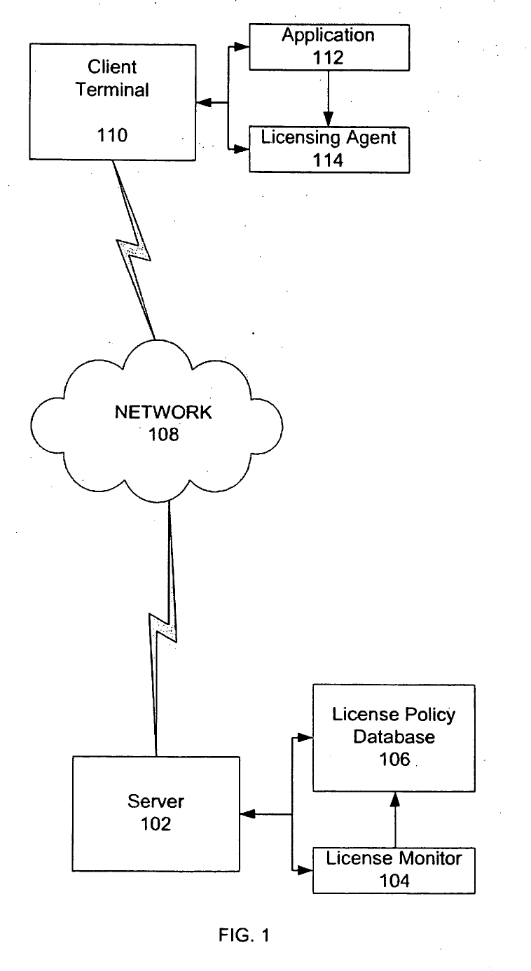

FIG. 1 shows a generalized block diagram of a system 100 for providing software license management to end user terminals in accordance with the principles of preferred embodiments of the present invention. System 100 may include a license management server 102, a license monitor 104, a license policy database 106, a network 108, and a user terminal 110 having software application 112, and license management agent 114.

Server 102 may be any suitable request-processing device such as a computer or other electronic administration point for communicating with terminal 110 and may request, initiate, control, and monitor the transfer of data between terminal 110 and various other endpoints (not shown) on network 108. Network 108 may be any public or private communications network such as a hard-wired or wireless WAN (wide area network) or LAN (local area network) suitable for transmitting electronic data. User terminal 110 may be any network endpoint having at least minimal processing capabilities such as a personal computer or workstation. Terminal 110 may include software application 112, which may be any suitable software application provided for evaluation purposes that requires a license to operate. Although only one server 102 and one terminal 110 are shown in FIG. 1, it will be understood that additional servers and/or terminals may be added to system 100 if desired.

Generally speaking, the system of FIG. 1 may operate as follows. Software application 112 is installed on terminal 110 (either directly or from a remote computer with access to network 108 (not shown)). In order to use application 112, terminal 110 may need to receive operating permissions (e.g., license privileges). These permissions may be obtained from server 102. For example, operating privileges may be stored in database 106 on server 102, and may further include some or all of the license policies and privilege rules for a given set of terminals 110 connected to network 108.

Thus, in operation, when a user attempts to invoke an instance of application program 112, terminal 110 may consult with server 102 to obtain the necessary permission. This may be accomplished using licensing agent 114, which may interface with server 102 to determine what privileges (if any) are required. If the necessary permission is obtained, the user may be granted access to application 112. If the necessary permission is not obtained, the user may be denied access to application 112.

In the case where an evaluation version of software is being invoked, server 102 and database 106 may determine if the evaluation period has expired or if other restrictions are applicable to the particular application 112 for which an end user is requesting access. For example, certain applications 112 may have user-based restrictions (e.g., functionality, geographic location, privilege level, or other restrictions). Moreover, different end users may be subject to different evaluation periods such that one end user's trial period may be longer or shorter than another end user's. Other criteria, such as security level, particular terminal, or particular network may also play a role in determining whether access should be granted.

Once it has been determined that a user is authorized to access a particular application 112, server 102 may transmit the necessary license information to terminal 110 to grant access. This license information may include any suitable electronic access or license policy information such as a Public or Private Key Information (PKI), verified digital signature, or any other license files or keys necessary to grant application access. In alternative embodiments, some or all the license information may be stored locally at each terminal 110, with server 102 merely approving or providing access to that information (which may be encrypted or otherwise encoded to prevent unauthorized local access).

In one embodiment of the invention, server 102 may store all license policies or information in database 106. Each of these policies may be associated with an application 112 and may be identified by a unique global identifier. In some embodiments, each of these identifiers may be further encoded such that each identifier may be understood and accessed only by server 102. Such identifiers may be based, at least in part, on some unique criteria associated with a particular terminal to prevent a particular license file associated with an application from being used on multiple terminals 110. For example, the identifiers may be based on the Media Access Address (MAC ID, sometimes referred to as the Ethernet address) of a terminal 110 on network 108.

Server 102 may also include unique identifiers that correspond to each application 112 deployed on terminals 110 and may use this information to correlate applications with license policies in database 106. Moreover, if desired, network administrators may assign different privilege levels to different end users of terminals 110 by defining and assigning such privilege levels in server 102. In some embodiments, end users with different privilege levels may connect to server 102 at different I/O ports or sockets.

As shown in FIG. 1, license management system 100 may also deploy licensing management agent 114, which may reside locally within terminal 110 (or elsewhere in the network). Agent 114 may include software that allows application 112 to connect to and interface with server 102 and database 106 in order to request and obtain the necessary license policies or operating permission(s). For example, agent 114 may include a library of communication and interface files, which may include an application programming interface for a specific application 112. These communication and interface files may be used to connect to server 102 and may support the particular application 112 (not shown). The library may include a comprehensive set of files for interfacing with some or all of the license policies present in server 102, but should include at a minimum the files necessary to support currently resident applications.

System 100 may also include license monitor 104 deployed in server 102. Monitor 104 may monitor server 102 and database 106 for license policy consistency and for any violation of that policy by applications 112 running on terminals 110. Monitor 104 may accomplish this by periodically or, in some embodiments, continuously monitoring the license policies stored in server 102 and database 106. For example, monitor 104 may detect and react to any violation of the rules established for application management by a software vendor or network administrator. Notification of violations may include sending a trouble ticket or report to the network manager, software developer or vendor advising that party of a detected violation. Other actions that may be taken by monitor 104 include initiating the immediate or subsequent termination of application privileges for any application found to be or suspected of being in violation of the rules configured within monitor 104.

Generally speaking, system 100 may operate in at least two modes of operation—one in which server 102 and monitor 104 ignore the defined unique address and one in which they do not. When the defined unique address is ignored, the license for that application 112 is considered valid by system 100 and the associated application 112 may operate. When the defined unique address is detected and it does not match, all license policies with that address are rendered invalid and any associated application 112 becomes disabled.

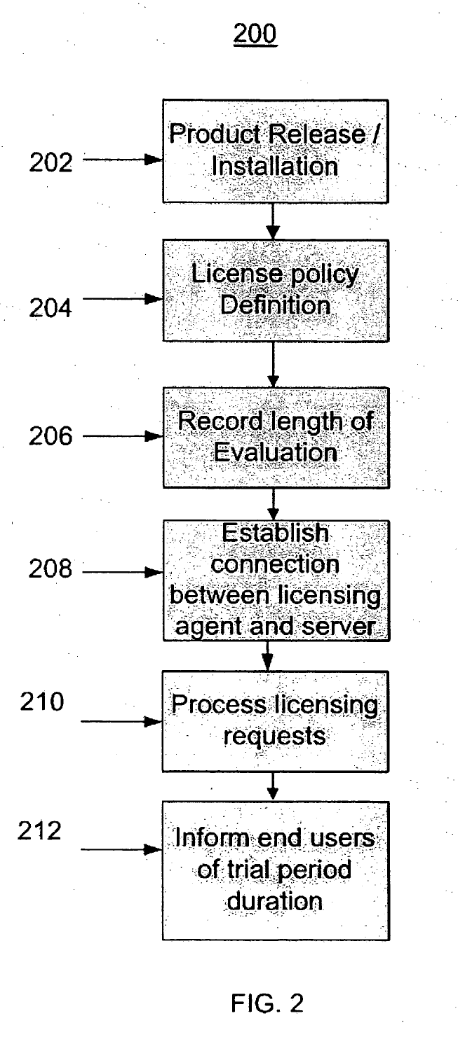

Some of the steps involved in performing the license management techniques of the present invention are illustrated in flow chart 200 shown in FIG. 2. As shown, at step 202, application program 112 may be installed on terminal 110 with a trial license period that is independent of the machine it is installed on. This may be accomplished by defining a unique address that is recognized by server 102 (e.g., with the MAC ID) but is not actually present on the network. The installation process may also include installing the appropriate general trial period license information on server 102 and database 106.

Next, at step 204, the application license policies may be defined and fully installed on server 102. This may include mapping and storing the appropriate license files in database 106 in a format that may be readable only by server 102 (which may include database 106 and monitor 104). At this point, server 102 may account for application licenses on a “counted” or “uncounted” basis. A counted license policy allows an application to reserve a specific number of licenses for that application. An uncounted license may only provide an indication as to whether a particular license is active or inactive and may typically operate on a first come first served basis. System 100 may have maximum number of allowed licenses (the “system maximum”) for each application that cannot be exceeded (without violating license management rules).

At step 206, the duration of the evaluation period for each application is recorded in server 102. Typically, this value is non-user configurable (i.e., it is established by someone other than the end user, such as by a software vendor or developer) and is defined prior to the installing of the application.

At step 208, the installed application 112 may connect to server 102 using license management agent 114. Agent 114 may use the configured server address to establish communications with server 102. Users with administration privileges may be able to connect to server 102 to retrieve, deploy, or update license policy information for an installed instance of application 112. At this point, application 112 may connect to server 102 through agent 114 to retrieve the availability or unavailability of a (uncounted) license or to reserve or unreserve a (counted) license policy. Server 102 may release all reserved licenses of a particular application if communication is lost between server 102 and terminal 110.

At step 210, license requests may be processed by server 102 during the duration of a trial period for a particular application 112. During this period, license requests may be granted up to the system maximum defined for each counted license. Uncounted license policies may be enabled and freely used throughout an entire defined trial period.

The duration of a trial period for a given application 112 may be maintained in persistent storage, and in some embodiments, may be retained even after the removal of that particular application from system 100. The trial period's operating duration may be updated periodically (e.g., daily) or substantially continuously (e.g., every several clock cycles). At the end of the trial period, the defined unique address may be moved from the ignored category to the detected category, thereby rendering all license policies issued for that unique address invalid, and disabling the associated application 112 running on a particular terminal 110. An attempt to reuse the existing license policies on terminal 110 will fail after the trial period has ended. Similarly, an attempt to use a currently valid license policy from another terminal 110 for the same application 112 will also fail (due to the difference in the unique identifiers).

In the case where a license policy is being updated on terminal 110, the unique address is transferred from the ignored to the detected category. System 100 may operate in the non-evaluation mode after successful installation of a new license policy. If the installation of the new license policy fails, then the unique address is transferred back to the ignored category from the detected category, and the application renews operation at the point at which it was stopped (until completion of the trial period defined by that application).

At step 212, monitor 104 may inform users about the pending expiration of an application's license policy so users may take the appropriate steps to purchase the trial period software before the current version is permanently disabled. After monitor 104 determines the trial period has expired, Application 112 may be permanently disabled.

Thus, systems and methods for the administration of software licenses are provided. It will be understood that the foregoing is only illustrative of the principles of the invention and that various modifications may be made by those skilled in the art without departing from the scope and spirit of the invention. Accordingly, such embodiments will be recognized as within the scope of the present invention.

Persons skilled in the art will appreciate that the present invention may be practiced by other than the described embodiments, which are presented for purposes of illustration rather than of limitation and that the present invention is limited only by the claims that follow.

What is claimed is:

1. A system for managing license privileges associated with software provided for an evaluation period, the system comprising:
a user terminal on which an application program is installed;
a license management server coupled to the user terminal through a network, wherein the license management server includes a database of license policies for at least in part authorizing the use of a plurality of programs including the application program; and
a license monitor that monitors the application program and the license policy database to determine when an evaluation period for the application program expires.

2. The system of claim 1, wherein the license monitor disables the application program after the evaluation period expires.

3. The system of claim 1, wherein the user terminal includes a license management agent configured for communicating with the license management server.

4. The system of claim 3, wherein the license management agent is further configured to request and obtain licenses and optionally a user definable operating permission for a particular user terminal.

5. The system of claim 1, wherein the application program is assigned a unique address identifier.

6. The system of claim 5, wherein the address identifier correlates a particular application with a particular license policy and optionally a user definable operating permission.

7. The system of claim 5, wherein the address identifier is associated with a particular user terminal.

8. The system of claim 5, wherein the address identifier is encoded such that it may only be accessed by the license management server.

9. A method for managing license privileges associated with software provided for an evaluation period, the system comprising:
installing an application program on a user terminal;
transmitting license information necessary to operate the application program from the user terminal to a license management server, wherein the license information includes a duration of a trial period for the application program;
storing the license information in a database;
monitoring the license information to determine when the trial period expires; and
disabling the application program after the expiration of the trial period.

10. The method of claim 9, further comprising between the steps of storing the license information and monitoring the license information, assigning the application program a unique address identifier.

11. The method of claim 10, wherein the address identifier correlates a particular application with a particular license policy and optionally a user definable operating permission.

12. The method of claim 10, wherein the address identifier is associated with a particular user terminal.

13. The method of claim 10, wherein the address identifier is encoded such that it may only be accessed by the license management server.

14. A system for managing license privileges associated with software provided for an evaluation period, the system comprising:
a means for installing an application program on a user terminal;
a means for transmitting license information necessary to operate the application program from the user terminal to a license management server, wherein the license information includes a duration of a trial period for the application program;
a means for storing the license information in a database;
a means for monitoring the license information to determine when the trial period expires; and
a means for disabling the application program after the expiration of the trial period.

15. The system of claim 14, further comprising a means for assigning the application program a unique address identifier.

16. The system of claim 15, wherein the means for assigning the address identifier correlates a particular application with a particular license policy and optionally a user definable operating permission.

17. The system of claim 15, wherein the means for assigning the address identifier associates the address identifier with a particular user terminal.

18. The system of claim 15, wherein the means for assigning the address identifier encodes the identifier such that it may only be accessed by the licensing management server.
